(19) United States
(12) Patent Application Publication
(10) Pub. No.: US 2026/0159418 A1
(43) Pub. Date: Jun. 11, 2026

(54) KETTLE-TYPE WATER PURIFIER HAVING PERFORMANCE AND USER CONVENIENCE

(71) Applicant: KORTECH KOREA CO., LTD., Daegu (KR)

(72) Inventor: Je Sung PARK, Daegu (KR)

(21) Appl. No.: 18/717,796

(22) PCT Filed: Dec. 22, 2022
(86) PCT No.: PCT/KR2022/021104

§ 371 Date: Jun. 7, 2024

(30) Foreign Application Priority Data
Dec. 22, 2022 (KR) 10-2022-0181935

(51) Int. Cl. C02F 1/00; C02F 9/20

(52) U.S. Cl. CPC C02F 1/003; C02F 9/20; C02F 2307/04

(57) ABSTRACT

Proposed is a kettle-type water purifier having performance and user convenience, which is convenient in the use of original water and purified water, provides easy replacement and easy charging of a filter, and also improves convenience and versatility of portability according to the compact and small size of the water purifier, in particular, as a structure including a base unit that makes the state of original water the state of purified water by filtering the original water introduced through a purified water filter unit installed therein in a way to filter and treat the original water, and a storage container unit mounted at the top of the base unit, separated from the base unit, and configured to store the original water and the purified water in a structure for a separation space.

### TECHNICAL FIELD

The present disclosure relates to a kettle-type water purifier having performance and user convenience, and is more particularly intended to provide a kettle-type water purifier that is compact and reduced in size and that has high quality and to a kettle-type water purifier having performance and user convenience, which can provide convenience and versatility of portability along with user convenience according to storage through a double separation space for original water and purified water, excellent filtering treatment according to the application of a high-quality filter, and the prevention of secondary pollution according to the blocking of a water leak.

### BACKGROUND ART

Most of the existing common kettle-type water purifiers that are distributed and sold in the market have a structure in which a filtering device 2 that filters water is installed over a container 1 as illustrated in FIG. 10, for example. A filter 3 using powdered activated carbon or ion exchange resin is constructed within the filtering device 2. The existing common kettle-type water purifier has a construction including a cover 4 that opens and closes the entrance of the top of the container 1.

In particular, the filter 3 is a low-quality (an adsorption type, a flow velocity is slow) filter according to natural pressure, and adopts cheap powdered activated carbon and ion exchange resin. There is a problem in that the weight of the entire product is increased due to the weight of the mounted filter in a moving process with the water purifier being carried or when water is poured due to a structure in which the filtering device 2 including the filter 3 is installed on the upper side of the container 1.

Furthermore, it is difficult to apply a high-quality (a precision filtering type, such as an ultra-filtration membrane filter or a block activated carbon filter, a flow velocity is fast) filter to the filter having an adsorption method into which powdered activated carbon and ion exchange resin has been input because purified water of production water is filtered by natural pressure. A significantly small amount of purified water comes out. In view of the characteristics of a filtering method dependent on natural pressure, there is a problem in that original water and production water may be mixed in a process of pouring water because original water is not filtered as 100% production water and some of the original water remains as residual water in an original water storage tank.

Furthermore, in the existing kettle-type water purifier, the filter is installed on the upper side of the container. Accordingly, in a filter exchange process of the water purifier, the cover and the original water storage tank need to be separated, and the filter needs to be separated toward the outside by pulling the filter by the hand in order to exchange the filter mounted within the original water storage tank. Accordingly, a consumer feels inconvenient in the replacement and management of the filter. In the exchange process of the filter, the original water storage tank is touched by a customer's hand that has been contaminated with germs or other impurities. There is a danger of a problem in terms of hygiene safety according to secondary pollution (contamination according to the introduction of germs, dust, or other harmful substances) because a mixing blocking function is not present between original water and production water.

Meanwhile, Patent Document disclosed in Prior Art Document is a Chinese utility model related to a water purifier in which a filtering device is installed on the upper side of a kettle.

### PRIOR ART DOCUMENT

Patent Document 001: Chinese Utility Model application No. 201320643894.7 (Oct. 18, 2013)

### DISCLOSURE

### Technical Problem

An object of the present disclosure for solving the aforementioned problems is to provide a kettle-type water purifier with improved performance and user convenience, which is designed to improve the existing feature water purifier that adopts a low-quality filter using a natural pressure method into a water purifier having a high-quality filter using pump pressure. Furthermore, an object of the present disclosure is to provide a kettle-type water purifier with improved usability, even when storing original water and purified water separately in distinct compartments, and to prevent secondary pollution (such as dust, impurities, and other harmful substances) that may occur during the filter replacement process by enabling the filter to be installed in a separate space detached from the storage tank, thus ensuring both performance and user convenience. Furthermore, an object of the present disclosure aims to provide a compact water purifier capable of storing original water and purified water corresponding to production water in independent, separate structures, thereby preventing mixing between the original and purified water. By incorporating high-quality filters, the invention seeks to achieve downsizing of premium water purifiers while ensuring both performance and user convenience.

### Technical Solution

An example of the present disclosure for achieving the aforementioned objects is characterized in a kettle-type water purifier with enhanced performance and user convenience. This includes a base unit that filters incoming water through an internally installed purification filter to produce purified water, and a storage container unit, mounted atop the base unit but separated from it, configured to store the original water and purified water in a compartmentalized structure. An example of the kettle-type water purifier having performance and user convenience is characterized in that the storage container unit further includes an original water storage tank formed as a structure for a space in which the original water is stored, and a purified water storage tank formed as a structure in which the purified water storage tank surrounds the original water storage tank outside the original water storage tank, capable of properly balancing the center of gravity of the entire kettle, and as a structure for a space in which the purified water filtered from the original water is stored in the separation space that is spaced apart from the original water storage tank at a predetermined isolation space.

An example of the kettle-type water purifier having performance and user convenience is characterized in that the base unit further includes a filter mounting unit formed at any one portion of an external appearance thereof and formed at any one portion of an external appearance thereof for an easy replacement of the purified water filter unit, and a pump installed at a portion adjacent to the purified water filter unit within a portion at which the purified water filter unit has been installed and configured to enable the original water introduced from the original water storage tank to be forcedly filtered as the purified water through the purified water filter unit and to forcedly transmit the filtered purified water up to the purified water storage tank.

An example of the kettle-type water purifier having performance and user convenience is characterized in that the purified water filter unit installed within the base unit includes a first filter unit installed on one side thereof and configured to primarily filter the original water that is introduced downward from the original water storage tank, a second filter unit installed at a portion that neighbors the first filter unit and configured to secondarily filter the original water that has been primarily filtered, and a third filter unit installed at a portion adjacent to the second filter unit, installed up to the other side thereof, and configured to tertiary filter the original water that has been secondarily filtered.

An example of the kettle-type water purifier having performance and user convenience is characterized in that it further includes a water leak blocking device configured to automatically block the purified water that is drained through a drain conduit formed as a structure that is upward vertical, at an end of an exhaust passage pipe formed as a horizontal structure that extends from the third filter unit, in order to prevent secondary pollution and a water leak when the purified water filter unit is replaced, wherein the water leak blocking device is installed between the purified water filter unit and the drain conduit.

An example of the kettle-type water purifier having performance and user convenience is characterized in that the water leak blocking device further includes an opening and closing stopper configured to open and close an entrance of the drain conduit through a horizontal operational movement and to block a water leak of the purified water, and a spring having one end caught by a portion of the opening and closing stopper and the other end caught by an end of the exhaust passage pipe and involved in the horizontal operational movement of the opening and closing stopper depending on whether the water purification filter unit is installed or not.

An example of the kettle-type water purifier having performance and user convenience is characterized in that a bottom portion of the storage container unit further includes an original water inlet formed to lead the original water that has been stored in the original water storage tank toward the purified water filter unit constructed within the base unit, and a purified water outlet formed to drain the purified water that has been filtered through the purified water filter unit toward the purified water storage tank.

An example of the kettle-type water purifier having performance and user convenience is characterized in that an upper portion of the base unit further includes an inlet formed at a location corresponding to the original water inlet and configured to introduce the original water introduced from the original water inlet toward the purified water filter unit, and an outlet formed at a location corresponding to the purified water exit and configured to drain the purified water that has been filtered through the purified water filter unit toward the purified water outlet.

An example of the kettle-type water purifier having performance and user convenience is characterized in that the original water inlet and the purified water outlet each further includes therein an accommodation protrusion having a form in which the accommodation protrusion vertically protrudes in a predetermined downward direction, an inside accommodation protrusion surrounded by the accommodation protrusion within the accommodation protrusion and having a form in which the inside accommodation protrusion vertically protrudes in a predetermined downward direction, a packing ring inserted into an circumference of an outside of the accommodation protrusion, and an exhaust line having a form in which the exhaust line vertically protrudes in a predetermined upward direction at a central portion of the inside accommodation protrusion.

An example of the kettle-type water purifier having performance and user convenience is characterized in that the inlet and the outlet each further includes therein an accommodation groove having a depressed structure, a drainage protrusion hole configured to vertically protrude in a predetermined upward direction at a central portion of the accommodation groove, and a fitting tube configured to vertically protrude in a predetermined downward direction at the central portion of the accommodation groove.

### Advantageous Effects

The aforementioned kettle-type water purifier of the present disclosure has an advanced, compact, and small-sized structure. Original water and purified water can be used independently in a series of use processes of containing original water and purified water in order to fill the original water and the purified water or pouring the purified water in order to drink the purified water in the state in which the original water and the purified water have been stored in separation spaces having a dual structure. Accordingly, from a standpoint of users, there is an effect in that user convenience of original water and purified water are significantly improved.

Furthermore, according to the kettle-type water purifier of the present disclosure, the overall usability of the water purifier is significantly enhanced due to features such as external filter replacement in the filtration device, automatic water shut-off functionality, and effortless USB charging and operation. Furthermore, the kettle-type water purifier of the present disclosure has effects in an increased water output speed according to the application of the purified water filter unit having high quality, an easy exchange attributable to attachable and detachable replacement on the outside, the prevention of secondary pollution according to automatic water cut-off in an exchange process, and the prevention of the mixing of original water and purified water in a process of pouring water.

### BRIEF DESCRIPTION OF DRAWINGS

FIG. 1 is a three-dimensional drawing of an overall construction of an external appearance of a kettle-type water purifier having performance and user convenience according to an embodiment of the present disclosure.

FIG. 2 is a diagram illustrating a form of a plane, which is viewed at the top of the kettle-type water purifier of the present disclosure.

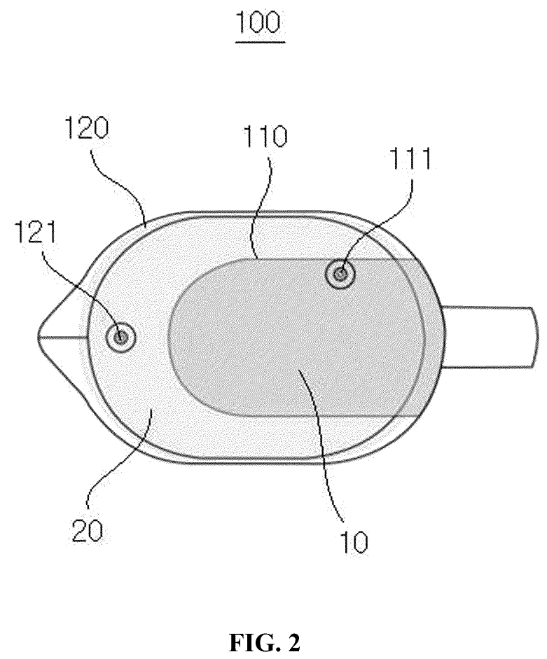

FIG. 3 is a three-dimensional drawing of an external appearance of a purified water filter unit and a pump installed within a base unit illustrated in FIG. 1.

FIG. 4 is an enlarged and detailed view illustrating a cross section of the purified water filter unit in order to check an internal structure of the purified water filter unit installed within a base unit illustrated in FIG. 1.

FIG. 5 is a cross section for checking an internal structure of an inlet and an outlet formed in an upper surface of the base unit illustrated in FIG. 1 and an internal structure of an original water inlet and a purified water outlet formed in a lower surface of a storage container unit, and is an enlarged view illustrating a structure having a coupling relation in which insertion units constructed in the original water inlet and the purified water outlet that have been formed in the lower surface of the storage container unit are inserted into the inlet and the outlet formed in the upper surface of the base unit in a way that the insertion units are accommodated in the inlet and the outlet when the storage container unit is mounted at the top of the base unit.

FIG. 6 is a diagram for conceptually checking a process of replacing the purified water filter unit in a filter mounting unit constructed in the base unit.

FIG. 7 is a cross section of the purified water filter unit and is a diagram for checking a structure of a water leak blocking device.

FIG. 8 is a diagram for checking a construction of a cover unit.

FIG. 9 is a diagram for conceptually checking a use process of the kettle-type water purifier of the present disclosure.

FIG. 10 is a diagram for illustrating a construction of a conventional common kettle-type water purifier.

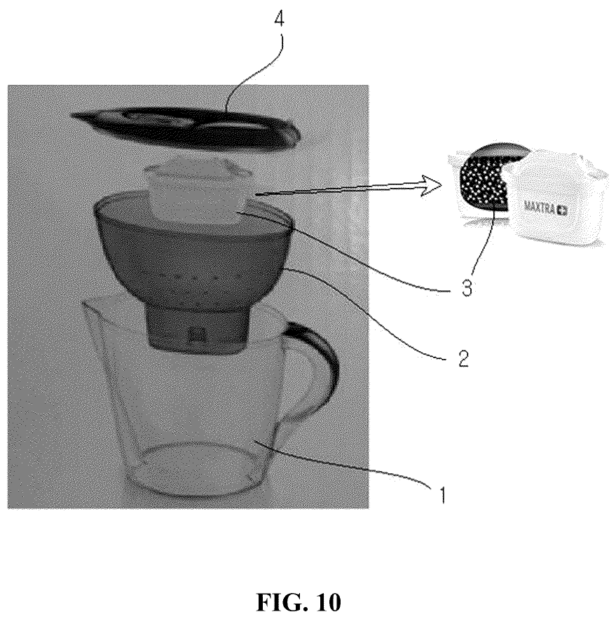

### BEST MODE

The present disclosure relates to a kettle-type water purifier having performance and user convenience. The kettle-type water purifier may include a base unit configured to make the state of original water the state of purified water by filtering the original water that is introduced through a purified water filter unit installed therein in a way to filter and treat the original water and a storage container unit mounted at the top of the base unit, separated from the base unit, and configured to store the original water and the purified water in a structure for a separation space.

The storage container unit may further include an original water storage tank formed as a structure for a space in which the original water is stored, and a purified water storage tank formed as a structure in which the purified water storage tank surrounds the original water storage tank outside the original water storage tank and as a structure for a space in which the purified water filtered from the original water is stored in the separation space that is spaced apart from the original water storage tank at a predetermined isolation space.

The base unit may further include a filter mounting unit formed at any one portion of an external appearance thereof and formed at any one portion of an external appearance thereof for an easy replacement of the purified water filter unit, and a pump installed at a portion adjacent to the purified water filter unit within a portion at which the purified water filter unit has been installed and configured to enable the original water introduced from the original water storage tank to be forcedly filtered as the purified water through the purified water filter unit and to forcedly transmit the filtered purified water up to the purified water storage tank.

### MODE FOR INVENTION

Embodiments that are described later in the present disclosure do not limit the scope of rights of the present disclosure, but are merely examples of components presented in the claims of the present disclosure and should be interpreted on the basis of the technical spirit of the entire specification in consideration of the fact that the present disclosure may be modified and implemented in other various forms. The drawings that are accompanied for reference of the present disclosure are merely reference for helping understanding of the present disclosure, and do not limit the technical right of the present disclosure.

Furthermore, in the present disclosure, unnecessary drawings of components are omitted in a way that the unnecessary drawings are not illustrated because components can be sufficiently understood in a descriptive way. However, the non-illustration cannot be pointed out as the reason for the lack of description of components of the present disclosure.

Hereinafter, a kettle-type water purifier having performance and user convenience according to an embodiment of the present disclosure is described in detail.

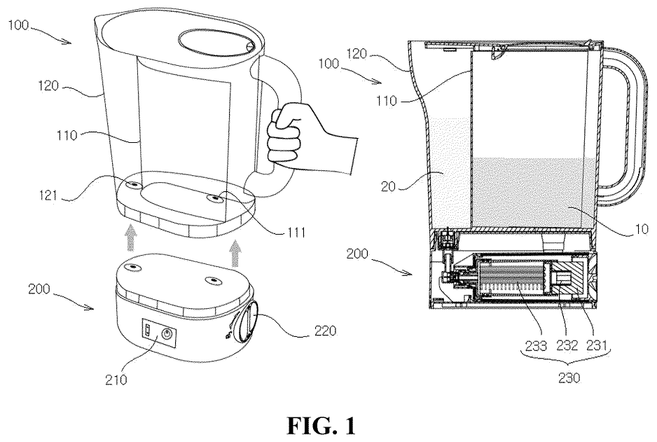

The water purifier according to an embodiment of the present disclosure may have a construction including a storage container unit 100 in which original water and purified water may be dually separated and contained and a base unit 200 provided for the mounting of the storage container unit under the storage container unit, for example, as illustrated in FIG. 1.

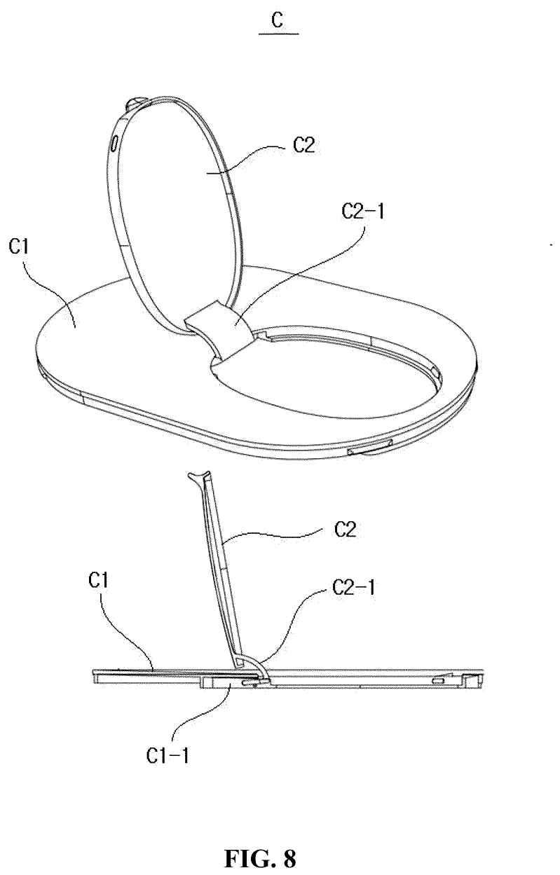

A cover unit C illustrated in FIG. 8, for example, is provided at the top of the storage container unit 100 so that the storage container unit 100 can be opened or closed, and the description regarding this configuration is given later.

The storage container unit 100 may be constructed as a dual storage structure including an original water storage tank 110 capable of containing and storing original water 10 and a purified water storage tank 120 capable of storing purified water 20.

In particular, the original water storage tank 110 and the purified water storage tank 120 have a ratio of 1:1 in the volume of spaces thereof. A barrier rib having a partition structure for the separation of the spaces of the original water storage tank 110 and the purified water storage tank 120 is constructed at a central portion of the storage container unit 100, that is, a kettle, so that the original water storage tank and the purified water storage tank may look like being full of water when visually viewed from the outside.

That is, the barrier rib that forms the original water storage tank 110 has a structure in which the barrier is vertically extended and formed from the bottom of the storage container unit 100 to an upper unit thereof, and may separate an internal space of the storage container unit 100 into two left and right spaces.

A detailed shape of the barrier rib is not limited to a special structural shape. A shape of a cross section that is horizontal to the bottom of the storage container unit 100 may form a shape of the entire straight line, and may form a shape of the entire curve according to circumstances or may form a combined structural shape including some straight line and some curve. The purified water storage tank 120 has a structure in which the purified water storage tank surrounds the original water storage tank 110, and is formed as a separation structure that maintains a predetermined isolation space from the original water storage tank 110 toward the outside.

That is, the storage container unit 100, that is, a kettle unit corresponding to an upper unit, is designed and constructed so that original water and purified water are carried in the state in which the original water and the purified water have been stored in the original water storage tank 110 and the purified water storage tank 120 as independent separation structures, respectively, without the connection of a filter.

The original water 10 and the purified water 20 may be stored in a separated way because the original water 10 may be stored in the original water storage tank 110 and the purified water 20 may be stored in the purified water storage tank 120.

An original water inlet 111 for introducing the original water 10 toward a purified water filter unit 230 installed within the base unit 200 is formed at any portion of the bottom of the original water storage tank 110.

A purified water outlet 121 for outputting the purified water 20 purified by the purified water filter unit 230 to the purified water storage tank 120 is formed at any portion of the bottom of the purified water storage tank 120.

That is, a portion of the bottom of the original water storage tank 110 and the purified water storage tank 120 has a construction that has been designed as two flow channels in which the original water inlet 111 necessary for the leading-in of the original water 10 that is downward introduced toward the base unit 200 and the purified water outlet 121 for upward outputting the purified water 20 that has been filtered through the purified water filter unit 230 constructed within the base unit 200 toward the purified water storage tank 120 have been formed.

Furthermore, check valves, although not illustrated, have been installed and applied to the original water inlet 111 and the purified water outlet 121. Accordingly, a back flow phenomenon which may occur in a fluid flow process of the original water 10 and the purified water 20 can be prevented.

The check valves are not limited to a specific type, and may include a swing check valve, a double disc swing check valve, a lift check valve, a ball check valve, and a smolensky check valve, for example, or may include other types. As means for reducing a water hammering phenomenon, such as noise and vibration which may be caused in a flow process of a fluid, the installation and application of the smolensky check valve, for example, is more preferred.

The original water 10 is tap water, for example, and is stored in the original water storage tank 110 and then stored in the purified water storage tank 120 in the state of the purified water 20 through purification treatment by which the original water is filtered by the purified water filter unit 230.

Accordingly, the original water 10 and the purified water 20 may be stored in the form of a separated structure. Users can easily drink the purified water 20 that has been separated as described above by pouring the purified water in a cup.

Meanwhile, the base unit 200 may have a construction including a manipulation plate 210 necessary for the operation of the water purifier installed at an external appearance portion thereof, a filter mounting unit 220 formed on any one side thereof, and the purified water filter unit 230 that is mounted through the filter mounting unit and that filters the original water 10 introduced from the original water storage tank 110 in the state of the purified water 20 within the base unit 200.

That is, the base unit 200 has a construction having a filter function, and is provided for use of a filter that filters original water introduced into the bottom of the storage container unit 100 in a way to mount the storage container unit 100, under the storage container unit 100 corresponding to the kettle.

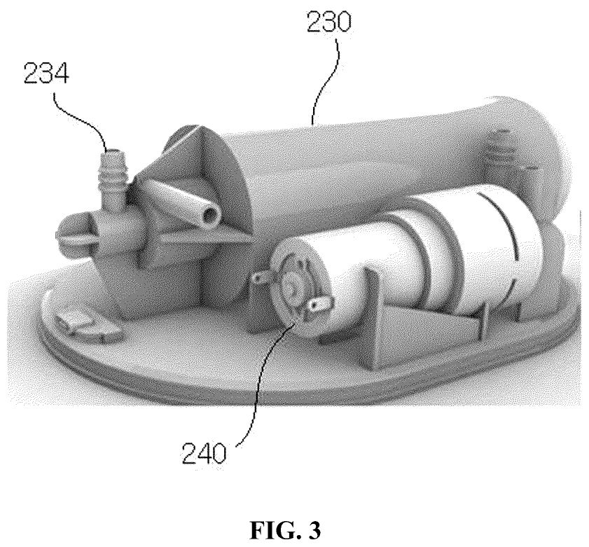

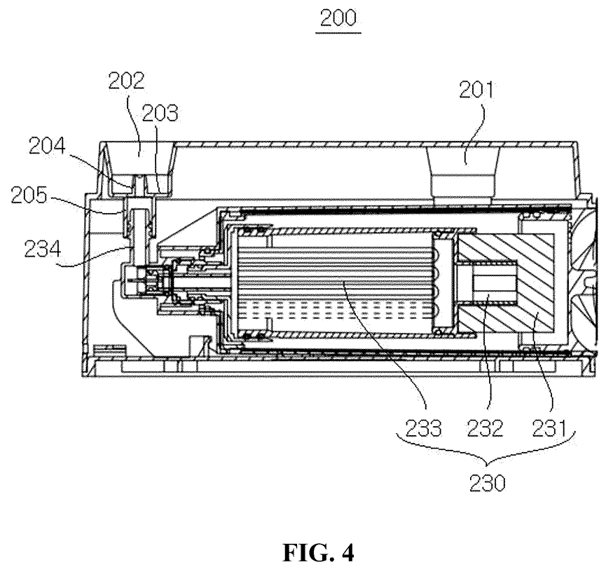

The purified water filter unit 230 may have a construction of a structure including a first filter unit 231, a second filter unit 232, and a third filter unit 233, as illustrated in FIGS. 3 and 4, for example, and has a structure including a drain conduit 234 that is vertically formed on the other side at any upper side of an external appearance thereof.

The first filter unit 231 has a structure in which the first filter unit is formed on any one side in the drawing, that is, under an inlet 201, and is a carbon fiber filter material, for example, which has excellent heat resistance and impact resistance and is resistant to chemicals.

The second filter unit 232 has a structure in which the second filter unit is formed at a location that neighbors the first filter unit 231, and is an adsorption filter material, for example. The second filter unit has an excellent adsorption ability compared to activated carbon, can perform filtering treatment a large amount of the original water 10 at a time, and can effectively remove a harmful substance included in the original water 10.

The third filter unit 233 has a structure in which the third filter unit is formed from a portion adjacent to the second filter unit 232 toward a location under the outlet 202, and is a ultrafiltration membrane, that is, a hollow fiber filter material, for example, and can effectively separately filter water or a material having an ion state.

Furthermore, a pump 240, such as that illustrated in FIG. 3, is installed on a side adjacent to the purified water filter unit 230. The pump 240 may forcedly transmit the original water 10 that is introduced through the inlet 201 from the original water storage tank 110 to the purified water storage tank 120 through the outlet 202 via the purified water filter unit 230.

Although not illustrated in the drawing, a separate charging port is constructed at any one portion of an external appearance of the base unit 200. The charging port may play a part in a convenient charging function of a USB terminal.

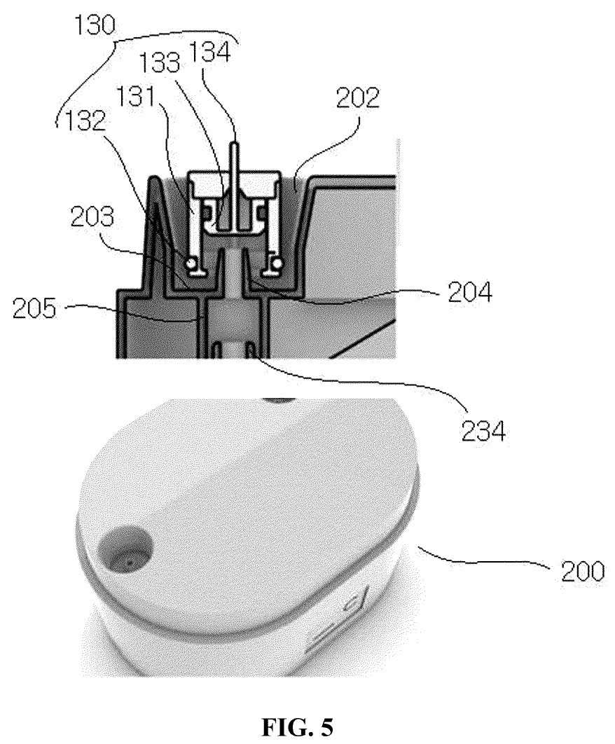

Meanwhile, a structure of an insertion unit 130, including an accommodation protrusion 131, a packing ring 132, an inside accommodation protrusion 133, and an exhaust line 134 as illustrated in FIG. 5, for example, may be constructed within each of the original water inlet 111 and the purified water outlet 121 formed at the bottom of the storage container unit 100.

That is, the insertion unit 130 formed within each of the original water inlet 111 and the purified water outlet 121 may be inserted into and mounted on each of the inlet 201 and the outlet 202 formed at the top of the base unit 200 in a way to be accommodated into each of the inlet and the outlet, when the storage container unit 100 is mounted at the top of the base unit 200.

In the insertion unit 130, the accommodation protrusion 131 has a structure in which the accommodation protrusion vertically downward protrudes. The packing ring 132 is sealed as a structure in which the packing ring is inserted along the circumference of the bottom of the accommodation protrusion 131, and can prevent a water leak of the purified water 20 that is drained from the drain conduit 234 to the outside.

That is, in the insertion unit 130 formed within each of the original water inlet 111 and the purified water outlet 121, the accommodation protrusion 131 has a protrusion structure in which the accommodation protrusion is vertical toward a downward direction thereof. The accommodation protrusion is inserted into an accommodation groove 203 formed as an internal structure of each of the inlet 201 and the outlet 202 formed at the top of the base unit 200 in a way to be accommodated into the accommodation groove.

The inside accommodation protrusion 133 has a structure in which the inside accommodation protrusion has been surrounded by the accommodation protrusion 131, and has a structure in which the inside accommodation protrusion has downward protruded in a predetermined vertical form within the accommodation protrusion 131. The exhaust line 134 has a structure in which the exhaust line has upward protruded at a central point of the inside accommodation protrusion 133 in a predetermined vertical form.

In this case, a drainage protrusion hole 204 formed within each of the inlet 201 and outlet 202 of the base unit 200 may be inserted into the accommodation protrusion 131 in a way to be accommodated in the accommodation protrusion, and may be then inserted up to the inside of the inside accommodation protrusion 133.

The inlet 201 and the outlet 202 formed at the top of the base unit 200 may be constructed as a structure, including the accommodation groove 203, the drainage protrusion hole 204, and a fitting tube 205 as illustrated in FIG. 5, for example.

The drainage protrusion hole 204 protrudes upward from a central portion of the accommodation groove 203 in a predetermined vertical form. The fitting tube 205 has a greater diameter than the drainage protrusion hole 204, and has a structure in which the fitting tube protrudes downward from the central portion of the accommodation groove 203 in a predetermined vertical form.

The fitting tube 205 may perform a functional use for inserting the drain conduit 234 that is vertically formed upward from an external appearance of the purified water filter unit 230.

Therefore, when the storage container unit 100 is mounted on the base unit 200, the accommodation protrusion 131 may be accommodated within the accommodation groove 203. At the same time, the drainage protrusion hole 204 may enter and may be inserted up to the inside accommodation protrusion 133 while being accommodated into the accommodation protrusion 131. The packing ring 132 can prevent the leakage of each of the original water 10 and the purified water 20 to the outside of each of the inlet 201 and the outlet 202. The purified water 20 that is discharged from the drainage protrusion hole 204 may be supplied to the purified water storage tank 120 through the exhaust line 134.

Accordingly, after the storage container unit 100 is mounted on the base unit 200, in a process of the kettle-type water purifier operating through a manipulation of the manipulation plate 210, the original water 10 that has been stored in the original water storage tank 110 of the storage container unit 100 may be introduced into the purified water filter unit 230 installed within the base unit 200 through the inlet 201 by an operation of the pump 240. The original water 10 may be filtered through the purified water filter unit 230 as described above, and may be supplied to the purified water storage tank 120 through the outlet 202 in the state of the purified water 20 in a way to be forcedly transmitted.

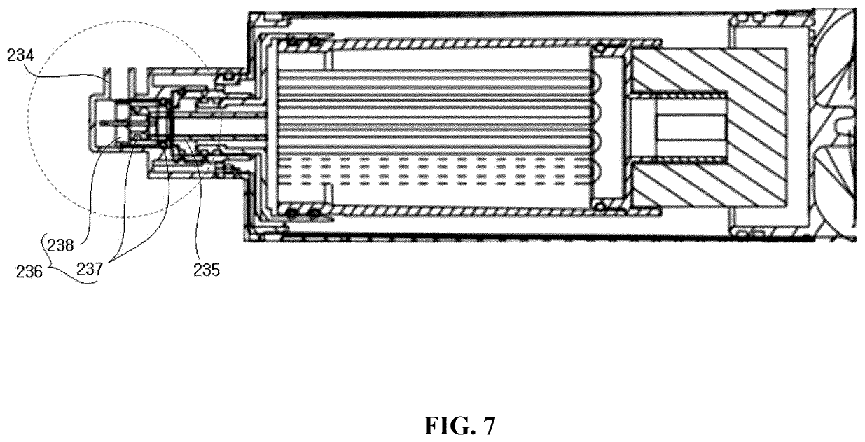

Meanwhile, an exhaust passage pipe 235 is constructed in the purified water filter unit 230 as a structure in which the exhaust passage pipe extends in a horizontal direction thereof between the third filter unit 233 and the drain conduit 234 as illustrated in FIG. 7, for example. The exhaust passage pipe has a structure in which a water leak blocking device 236 is installed at an end portion of the exhaust passage pipe 235.

That is, the water leak blocking device 236 is constructed as a structure in which the water leak blocking device includes a spring 237 and an opening and closing stopper 238. One end of the spring 237 is fixed as a structure in which the one end may be caught by the opening and closing stopper 238. The other end of the spring 237 is a structure that is fixed as a structure in which the other end may be caught by the exhaust passage pipe 235.

Accordingly, the purified water 20 that has been filtered through the third filter unit 233 of the purified water filter unit 230 opens the opening and closing stopper 238 that closes the entrance of the drain conduit 234 by a compression force according to an operation of the pump 240, and thus may be drained along the drain conduit 234.

The compression force for the purified water 20 disappears when the operation of the pump 240 is stopped. Accordingly, the opening and closing stopper 238 that has opened the entrance of the drain conduit 234 may return to its original location by an elastic restoring force of the spring 237 and close the entrance of the drain conduit 234 again. It is preferred that a tensile spring, for example, is used as the spring 237.

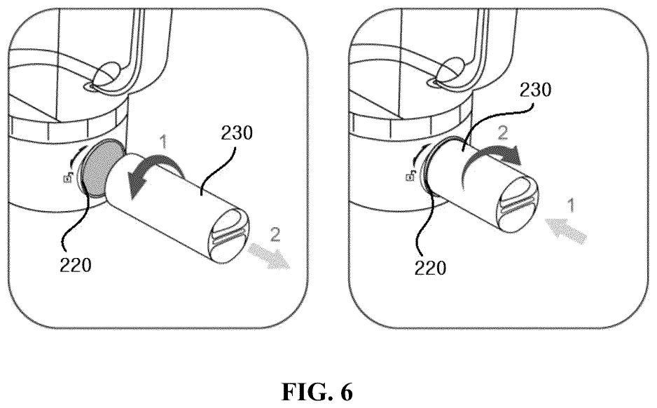

Furthermore, if the purified water filter unit 230 that has been installed in the filter mounting unit 220 in a way to be inserted into the filter mounting unit needs to be replaced, the purified water filter unit may be removed in a way to be separated toward an outward direction 2 by rotating the purified water filter unit in any one direction 1 as illustrated in FIG. 6, for example.

When being installed, the purified water filter unit 230 may be installed by being entered in the direction 1 of the filter mounting unit 220 and then rotated in the reverse direction 2 that is opposite to one direction in which the purified water filter unit is separated.

Meanwhile, the cover unit C, that is, a cover capable of opening and closing the top of the storage container unit 100, may be constructed as a structure including a first cover unit C1 for covering the purified water storage tank 120 and a second cover unit C2 for covering the original water storage tank 110 as illustrated in FIG. 8, for example.

In particular, the second cover unit C2 has a structure in which the second cover unit is connected to a connection member C2-1 in a way to slide along a slide long groove C1-1 formed within the first cover unit C1. Accordingly, even in the state in which the first cover unit C1 has covered the purified water storage tank 120, the second cover unit C2 may be independently opened by the connection member C2-1 that slides along the slide long groove C1-1, so that the original water 10 can be contained or poured in the original water storage tank 110.

That is, the weight sensitivity of the cover unit C is very light because the cover unit is used to frequently open and close the storage container unit 100. Furthermore, since the cover unit has a separated dual-cover structure including the second cover unit C2 that opens and closes the original water storage tank 110 and the first cover unit C1 that opens and closes the purified water storage tank 120. Accordingly, it is very convenient for users in a series of water purifier use processes of pouring original water and purified water or pouring original water and purified water in order to fill the storage container unit 100.

Meanwhile, Table 1 below relate to contents that indicate differences indicative of the water purifier product of the present disclosure and the existing water purifier feature product for each item. In the item of the filter, the product of the present disclosure can better remove germs and heavy metals than an activated carbon filter that is used in the existing feature product because the product of the present disclosure adopts an ultrafiltration membrane (UF) or CTO filter having high quality.

Furthermore, even in the item of the amount of water discharged, the product of the present disclosure shows excellent and high numerical values compared to the existing feature product. Even in the item of operating pressure, the product of the present disclosure shows excellent and high numerical values compared to the existing feature product. In the item of residual water, the product of the present disclosure has no residual water unlike in a phenomenon in which residual water generated in the existing feature product remains.

Furthermore, even in the item of the filter lifespan, the product of the present disclosure shows excellent numerical values compared to the existing filter product. Even in a filter exchange method, the existing feature product has a danger of secondary pollution and exchange inconvenience because the filter of the present disclosure is exchanged on the outside of the kettle, whereas the filter of the existing feature product is exchanged within the kettle. In the item of the mixing of storage water of original water, the product of the present disclosure has no danger of the mixing because the product has a left and right separation type. However, the existing feature product has the danger of the mixing depending on the angle of the kettle because the existing feature product is a top and bottom separation type.

TABLE 1

| | PRODUCT OF PRESENT | | EXISTING FEATURE | | |
|---|---|---|---|---|---|
| ITEM | DISCLOSURE | | PRODUCT | | NOTES |
| Filter | UF, CTO filter (germs or | | Activated carbon filter | | |
| | heavy metals removed) | | (chlorine or heavy | | |
| | | | metals partially | | |
| | | | removed) | | |
| Amount of water | 0.8 to 1.2 | liter/min | 0.1~0.3 | liter/min | Natural pressure, flow |
| discharged | | | | | velocity gradually |
| | | | | | becomes slow |
| Operating pressure | Pump 0.5 to 1 bar | | Natural pressure 0.01 | | |
| | | | to 0.05 bar | | |
| Residual water | No residual water | | Residual water | | Natural pressure, last |
| | | | remained | | residue not treated |
| Filter lifespan | 500 to 1000 | liters | 100 to 200 | liters | |

| | | | |
|---|---|---|---|
| Filter exchange | Exchange outside kettle | Exchange within kettle | Danger of secondary |
| method | | | pollution |
| Original water | Left and right separation | Top and bottom | Structural problem |
| Mixing of storage | type, no danger of mixing | separation type, danger | |
| water | | of mixing depending | |
| | | on angle of kettle | |

Hereinafter, an operational process of the kettle-type water purifier having performance and user convenience is described in detail.

In a process of treating purified water using original water, the original water (tap water) stored in the original water storage tank 110 is filtered as the purified water by sequentially passing through the first filter unit 231, second filter unit 232, and third filter unit 233 of the purified water filter unit 230 disposed under the original water storage tank 110 through the original water inlet 111 as the pump 240 operates.

In the process of the purified water filtered as described above being forcedly transmitted along the exhaust passage pipe 235, the spring 237 of the water leak blocking device 236 is stretched tensile, and simultaneously the opening and closing stopper 238 opens the drain conduit 234. When the drain conduit 234 is opened, the purified water is supplied to the purified water storage tank 120 disposed over the drain conduit 234 through the purified water outlet 121.

When the operation of the pump 240 is temporarily stopped, the stretched spring 237 is restored to its original location by an elastic restoring force thereof, and simultaneously the opening and closing stopper 238 that has opened the drain conduit 234 closes the drain conduit 234 again, so that the purified water is no longer drained.

Even in hygienic management according to the prevention of secondary pollution (pollution according to the introduction of dust, impurities, or other harmful substances), it is convenient because a water leak to the outside is blocked by the water leak blocking device 236 even in a process of replacing the purified water filter unit 230.

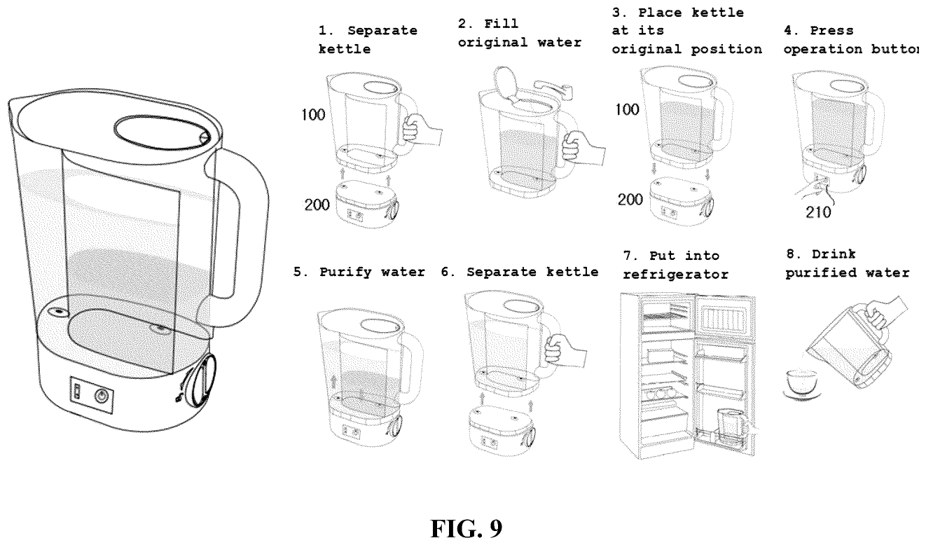

In the use of the water purifier, as manifestly illustrated in FIG. 9, for example, a process of using original water and purified water is very convenient. Above all, it is convenient in the frequent opening and closing of the cover unit that opens and closes the top of the storage container unit in view of the characteristics of the cover unit because the pump for forcedly transmitting water and the components of the filter are applied to the base unit disposed under the storage container unit corresponding to a kettle.

### DESCRIPTION OF REFERENCE NUMERALS

10: original water, 20: purified water, 100: storage container unit, 110: original water storage tank, 111: original water inlet,
120: purified water storage tank, 121: purified water outlet, 130: insertion part, 131: accommodation protrusion,
132: packing ring, 133: inside accommodation protrusion, 134: exhaust line, 200: base unit,
201: inlet, 202: depressed outlet, 203: accommodation groove, 204: drainage protrusion hole,
205: fitting tube, 210: manipulation plate, 220: filter mounting part, 230: purified water filter part,
231: first filter part, 232: second filter part, 233: third filter part
C: cover part, C1: first cover part, C1-1: slide long groove, C2: second cover part,
C2-1: connection member, 234: drain conduit, 235: exhaust passage pipe, 236: water leak blocking device,
237: spring, 238: opening and closing stopper, 240: pump

### INDUSTRIAL APPLICABILITY

The present disclosure relates to a kettle-type water purifier having performance and user convenience, and is more particularly intended to provide a kettle-type water purifier that is compact and reduced in size and that has high quality and to a kettle-type water purifier having performance and user convenience, which can provide convenience and versatility of portability along with user convenience according to storage through a double separation space for original water and purified water, excellent filtering treatment according to the application of a high-quality filter, and the prevention of secondary pollution according to the blocking of a water leak.

1. A kettle-type water purifier having performance and user convenience, comprising:
a base unit configured to make a state of original water a state of purified water by filtering the original water that is introduced through a purified water filter unit installed therein in a way to filter and treat the original water; and
a storage container unit mounted at a top of the base unit, separated from the base unit, and configured to store the original water and the purified water in a structure for a separation space.

2. The kettle-type water purifier of claim 1, wherein the storage container unit further comprises:
an original water storage tank formed as a structure for a space in which the original water is stored; and
a purified water storage tank formed as a structure in which the purified water storage tank surrounds the original water storage tank outside the original water storage tank and as a structure for a space in which the purified water filtered from the original water is stored in the separation space that is spaced apart from the original water storage tank at a predetermined isolation space.

3. The kettle-type water purifier of claim 2, wherein the base unit further comprises:
a filter mounting unit formed at any one portion of an external appearance thereof and formed at any one portion of an external appearance thereof for an easy replacement of the purified water filter part; and
a pump installed at a portion adjacent to the purified water filter unit within a portion at which the purified water filter unit has been installed and configured to enable the original water introduced from the original water storage tank to be forcedly filtered as the purified water through the purified water filter unit and to forcedly transmit the filtered purified water up to the purified water storage tank.

4. The kettle-type water purifier of claim 3, wherein the purified water filter unit installed within the base unit further comprises:
a first filter unit installed on one side thereof and configured to primarily filter the original water that is introduced downward from the original water storage tank;
a second filter unit installed at a portion that neighbors the first filter unit and configured to secondarily filter the original water that has been primarily filtered; and
a third filter unit installed at a portion adjacent to the second filter part, installed up to the other side thereof, and configured to tertiary filter the original water that has been secondarily filtered.

5. The kettle-type water purifier of claim 4, further comprising a water leak blocking device configured to automatically block the purified water that is drained through a drain conduit formed as a structure that is upward vertical, at an end of an exhaust passage pipe formed as a horizontal structure that extends from the third filter part, in order to prevent secondary pollution and a water leak when the purified water filter unit is replaced, wherein the water leak blocking device is installed between the purified water filter unit and the drain conduit.

6. The kettle-type water purifier of claim 5, wherein the water leak blocking device further comprises:
an opening and closing stopper configured to open and close an entrance of the drain conduit through a horizontal operational movement and to block a water leak of the purified water; and
a spring having one end caught by a portion of the opening and closing stopper and the other end caught by an end of the exhaust passage pipe and involved in the horizontal operational movement of the opening and closing stopper depending on whether a compression force for the purified water by the pump is present.

7. The kettle-type water purifier of claim 2, wherein a bottom portion of the storage container unit further comprises:
an original water inlet formed to lead the original water that has been stored in the original water storage tank toward the purified water filter unit constructed within the base unit; and
a purified water outlet formed to drain the purified water that has been filtered through the purified water filter unit toward the purified water storage tank.

8. The kettle-type water purifier of claim 7, wherein an upper portion of the base unit further comprises:
an inlet formed at a location corresponding to the original water inlet and configured to introduce the original water introduced from the original water inlet toward the purified water filter part; and
an outlet formed at a location corresponding to the purified water exit and configured to drain the purified water that has been filtered through the purified water filter unit toward the purified water outlet.

9. The kettle-type water purifier of claim 7, wherein the original water inlet and the purified water outlet each further comprises therein:
an accommodation protrusion having a form in which the accommodation protrusion vertically protrudes in a predetermined downward direction;
an inside accommodation protrusion surrounded by the accommodation protrusion within the accommodation protrusion and having a form in which the inside accommodation protrusion vertically protrudes in a predetermined downward direction;
a packing ring inserted into a circumference of an outside of the accommodation protrusion; and
an exhaust line having a form in which the exhaust line vertically protrudes in a predetermined upward direction at a central portion of the inside accommodation protrusion.

10. The kettle-type water purifier of claim 8, wherein the inlet and the outlet each further comprises therein:
an accommodation groove having a depressed structure;
a drainage protrusion hole configured to vertically protrude in a predetermined upward direction at a central portion of the accommodation groove; and
a fitting tube configured to vertically protrude in a predetermined downward direction at the central portion of the accommodation groove.
